(19) United States
(12) Patent Application Publication
(10) Pub. No.: US 2026/0200482 A1
(43) Pub. Date: Jul. 16, 2026

(54) SYSTEMS AND METHODS FOR MITIGATING VEHICLE BATTERY DRAIN

(71) Applicant: Ford Global Technologies, LLC, Dearborn, MI (US)

(72) Inventors: Stuart C. Salter, White Lake, MI (US); Steven Thomas DiLodovico, Grosse Pointe Farms, MI (US); John Budaj, West Bloomfield, MI (US); Milind Mishra, Ottawa (CA); Navbir Sidhu, Kanata (CA); Jeanne Xiao, Ottawa (CA); Yaron Spanglet, Ottawa (CA); Florian Frischmuth, Plymouth, MI (US)

(73) Assignee: Ford Global Technologies, LLC, Dearborn, MI (US)

(21) Appl. No.: 19/020,582

(22) Filed: Jan. 14, 2025

(51) Int. Cl. B60W 50/02; G07C 5/00

(52) U.S. Cl. CPC B60W 50/0225; B60W 50/0205; G07C 5/008; B60W 2510/244

(57) ABSTRACT

Systems and methods for mitigating vehicle battery drain are provided. Once a vehicle determines it is no longer in use (for example, after a key-off event of the vehicle), the vehicle may monitor the state of charge (SoC) of the battery that is used to power the various electronic control units (ECUs) of the vehicle (and/or other components of the vehicle that require an electrical power source to operate). The vehicle may take action in multiple phases depending on the current SoC of the battery and/or the rate of change of the SoC. A first phase is triggered if the SoC does not satisfy a first threshold SoC and/or the rate of change of the SoC is greater than or greater than or equal to a threshold rate of change. A second phase is triggered if the SoC falls even further and does not satisfy a second threshold SoC that is lower than the first threshold SoC.

### CROSS-REFERENCE TO RELATED APPLICATIONS

This application claims priority to and benefit of U.S. provisional Ser. No. 63/679,260 filed Aug. 5, 2024, which is herein incorporated by reference.

### BACKGROUND

In some instances, different vehicle ECUs may unintentionally remain “awake” (operational) even when a vehicle is no longer in use (for example, after a “key-off” event of the vehicle, etc.). These ECUs may require power from the vehicle's battery to operate, thus unnecessarily draining the battery while the vehicle is turned off after extended periods of time. If the battery is drained below a threshold state of charge (SoC), the vehicle also may not start until the battery is recharged, causing inconvenience for a user of the vehicle.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIGS. 1-2 depict flow diagrams for mitigating vehicle battery drain, in accordance with the present disclosure.

FIG. 3 depicts an environment in which techniques and structures for providing the systems and methods disclosed herein may be implemented, in accordance with the present disclosure.

### DETAILED DESCRIPTION

### Overview

The present disclosure describes systems and methods for mitigating vehicle battery drain. Particularly, the vehicle may monitor the state of charge (SoC) of the battery (or batteries) that is used to power the various electronic control units (ECUs) of the vehicle (and/or other components of the vehicle that require an electrical power source to operate). For example, in traditional internal combustion engine (ICE) vehicles, this may be the primary 12V battery. However, other types of batteries may also be monitored depending on the specific type of vehicle (this process is not necessarily limited to ICE vehicles). As indicated previously, this battery drain is often caused by certain ECUs inadvertently remaining “awake” (operational) even after the vehicle is no longer in use (for example, after a “key-off” event has occurred). Depending on the current SoC of the battery, the vehicle may send signals to reset certain ECUs in an attempt to cause the ECUs to transition to a “sleep” (non-operational) state to reduce the battery drain.

This process may be performed in multiple phases depending on the current SoC of the battery and/or the rate at which the SoC of the battery is decreasing. A first phase may be triggered if the vehicle determines that the SoC of the battery does not satisfy a first battery SoC threshold. For example, the first battery SoC threshold may be 55%. The first phase may also be based on the rate of change of the battery SoC as well. For example, for the first phase to be triggered, it may also be required that the rate of change of the SoC is greater than or equal to (or only greater than) a rate of change threshold. As a non-limiting example, the rate of change threshold may be 2% per hour. These two conditions may also individually trigger the first phase without requiring both conditions to be met. The purpose of the first phase is to mitigate battery drain while the SoC remains at a reasonable level without stopping normal operations of the vehicle.

The process associated with the first phase may be as follows. First, the vehicle may determine that it is no longer in use. Specifically, in one or more embodiments, the vehicle may determine that it is no longer in use when a “key-off” event has occurred (or the vehicle is otherwise in a “key-off” mode. The “key-off” event may generally refer to the vehicle ignition transitioning into an “off” state, and the “key-off” mode is the mode when the vehicle is in that off state. The determination that the vehicle is no longer in use is not necessarily limited to the vehicle being in a “key-off” state and may also (or alternatively) be made based on other conditions. As one additional non-limiting example, the ignition signal may be replaced by a power state signal (e.g., running, accessory, sleep, critical battery, asleep but powering critical loads, etc.).

The manner by which the vehicle determines it is no longer in use may also depend on the type of vehicle. For example, an electric vehicle (EV) does not have an ignition found in an ICE vehicle. Accordingly, the EV may determine it is no longer in use based on other condition(s). For example, the vehicle may determine that there are no occupants within the vehicle (e.g., using the sensor suite of the vehicle or through any other suitable methods) and that the vehicle is been locked. In some instances, the vehicle may also determine that a threshold amount of time has passed to ensure that the driver or any passengers do not intend to re-enter the vehicle. Some vehicles may have auto-lock functions and a user may temporarily exit from the vehicle with the intent to re-enter the vehicle and drive the vehicle. The vehicle may also use other techniques, such as determining that the driver and any passengers have walked a threshold distance away from the vehicle.

Regardless of the type of vehicle, once the vehicle determines that it is no longer in use, the vehicle may then wait a certain amount of time before checking the SoC of the battery. The vehicle may wait this period of time to ensure that all of the different ECUs of the vehicle have had sufficient time to complete any necessary operations (per normal operation of the vehicle) before entering a sleep state in which the ECUs no longer draw power from the battery. For example, the vehicle may wait four hours before checking the SoC of the battery, however, other periods of time are also possible. This amount of time may either be pre-established manually by a user or may be automatically determined by the vehicle.

The period of time that the vehicle waits may not necessarily always be a static amount of time but rather may be dynamic and may vary for different vehicles. For example, a first vehicle may have more ECUs or more complex systems than a second vehicle, and thus, the ECUs of the first vehicle may take longer to complete these necessary operations. Accordingly, the amount of time the first vehicle waits before checking the SoC of the batter may be greater than the amount of time the second vehicle waits. As another example, a first vehicle may have newer ECUs with greater processing power and speed than a second vehicle. In this example, the amount of time the first vehicle waits before checking the SoC of the batter may be less than the amount of time the second vehicle waits because the ECUs of the first vehicle are able to perform tasks quicker than the ECUs of the second vehicle.

This dynamic waiting time may also be applicable to the same vehicle. For example, the vehicle may have stored in memory (or remotely on a separate device, such as a server) a list of ECUs and the operations that the ECUs perform at “key-off.” The ECUs may communicate information about the tasks the ECUs are performing (for example, via the CAN bus of the vehicle or via any other communication protocol). Accordingly, rather than the vehicle waiting a fixed amount of time, the vehicle may wait until the last ECU performing tasks communicates an indication that it has completed its necessary tasks.

The vehicle does not necessarily always need to wait this period of time before beginning to monitor the SoC of the battery. In some instances, the vehicle may also immediately begin monitoring the SoC after it is determined that the vehicle is in the key-off mode (or other conditions that may be used to determine the vehicle is no longer in use). The monitoring of the SoC may be performed in real-time, or the SoC may be periodically obtained at certain time intervals.

While reference is made to the “vehicle” performing certain operations as described herein, these operations may specifically be performed by the enhanced central gateway (ECG) of the vehicle or any other ECU of the vehicle. However, this is not intended to be limiting, and the operations may also be performed by any other component with processing capabilities. The operations also do not necessarily need to be performed by the vehicle itself. Rather instructions may be transmitted to the vehicle from a remote system, device, etc. For example, a remote server may be configured to send control instructions to the vehicle. This may be particularly beneficial in the use case of a fleet of vehicles. A remote system may be configured to receive SoC and other information from vehicles in a fleet and may send control instructions to the vehicle in accordance with the first and second phases as described herein. As another example, a vehicle owner may remotely control the operations of their vehicle using a smartphone application. The vehicle may also be controlled remotely in any other manner.

Once the vehicle determines it is no longer in use and begins to monitor the SoC of the battery, if the vehicle determines at least one of: (1) the SoC does not satisfy a first threshold value and (2) the SoC is decreasing by a second threshold amount (or greater than the second threshold amount), then the aforementioned first phase may be triggered. As one non-limiting example, the first threshold may be 55% SoC, and the second threshold amount may be 2%, however, other values may also be used for any of the thresholds.

In the first phase, the vehicle may determine which of the ECUs are still awake and operational (e.g., drawing power from the battery). The vehicle may make this determination by identifying which of the ECUs are still sending communications via the controller area network (CAN) bus of the vehicle (however, the determination may also be made in other ways as well). The vehicle may then send reset signals (for example, over the CAN bus) to those ECUs. These reset signals typically clear any errors or other anomalous conditions of the ECU to allow the ECU to then enter a sleep mode to cease (or reduce) power drawn from the battery.

It may not necessarily be desirable for the vehicle to send reset signals to all of the ECUs that are still operational, however. For example, it may be desirable for some ECUs that are performing critical functions to remain operational, even if those ECUs draw power from the battery. Therefore, the vehicle may only send the reset signals to the ECUs that are not performing a critical function. The vehicle may determine if an ECU is performing a critical function in different ways. For example, the vehicle may determine if certain bits are sent in communications transmitted by the ECU (which may indicate that such critical functions are being performed). As another example, the vehicle may store information about ECUs responsible for critical functions and may simply not send the reset signals based on this information that the ECUs typically serve the critical function.

Even after the reset signals have been sent, the vehicle may continue to monitor the SoC of the battery (and/or the rate of change of the SoC). If the battery drain continues, then the vehicle may repeat the first process until the battery drain falls below another threshold SoC.

If, at any point in this process, the battery SoC is determined to not satisfy a second threshold SoC (which may be 40%, for example), then a second phase may be triggered. The second phase may also be triggered initially (rather than the first phase preceding the second phase) if the vehicle determines that the battery SoC already does not satisfy the second battery SoC threshold when the initial SoC check is performed. During this second phase, the reset signals are still sent to the ECUs that are determined to still be operational. However, in contrast with the first phase, the second phase also involves the ECG performing a self-reset process. Self-resetting the ECG of the vehicle may hinder normal operations of the vehicle, so this process is only leveraged if the battery SoC is determined to be critical (based on the second threshold). The goal of the second phase is to mitigate or eliminate the battery drain before the battery SoC drops too far and prevents the vehicle from starting.

The process associated with the second phase may include some similar operations as the first phase and may be as follows. As previously indicated, if the vehicle determines that the battery SoC does not satisfy the second battery SoC threshold (which may be 40%, for example), then the second phase is triggered, and the vehicle determines which of the ECUs are still awake and functional (e.g., drawing power from the battery). Before this determination is made, however, the vehicle may initiate a timer to allow the battery to “settle.” A vehicle component may have temporarily pulled down the surface charge, and the battery may settle over time. The use of this timer ensures that this condition does not occur (if the condition does occur, then the battery may no longer be equal to or less than the second threshold SoC. For example, this timer may be 20 minutes or any other period of time.

Once the timer has elapsed and the battery SoC is still less than or equal to the second threshold, the vehicle may then determine which of the ECUs are still awake and active. As previously indicated, the vehicle may make this determination by identifying which of the ECUs are still sending communications via the controller area network (CAN) bus of the vehicle. The vehicle may then send reset signals (for example, over the CAN bus) to those ECUs. The vehicle may also perform a self-reset of the ECG along with sending the reset signals to the ECUs. This process may be iterated in some instances as well.

While reference is made specifically to the first battery SoC threshold being 55% and the second battery SoC threshold being 40%, these are not intended to be limiting, and other thresholds are also possible. The same may be applicable to any other thresholds described herein (such as the rate of change threshold for the SoC considered as part of the first phase trigger).

The thresholds may also be manually adjustable by a user, such as an owner of the vehicle, a fleet manager, an original equipment manufacturer, a mechanic, etc. For example, the user may manually indicate that the first threshold should be adjusted to 50%. This change may be indicated to the vehicle in any number of different ways. Non-limiting examples may include commands sent to the vehicle via an onboard diagnostic (OBD) device that is plugged into an OBD port of the vehicle or commands sent remotely from another device, such as a smartphone or desktop/laptop computer of a user. The adjustment may be indicated to the vehicle in other ways as well. Additionally, in some instances the thresholds may be dynamic and automatically adjusted by the vehicle based on various factors, such as the age of the battery, the temperature of the battery (and/or the ambient temperature in the environment), the average power draw of the various ECUs that use the battery as a power source, the current distance the vehicle is from the owner's place of residence (more conservative thresholds may be applied), and/or any other relevant factors that may change the battery charge.

Additionally, any reference to the vehicle determining whether a value is less than or equal to a threshold is not necessarily intended to be limiting. For example, it is indicated above that the vehicle determines whether the SoC of the vehicle is less than or equal to 55% as part of the determination for triggering the first phase. However, this determination may instead consider whether the SoC is only less than the threshold rather than considering if the SoC is less than or equal to the threshold. This is also applicable to any other comparisons with any other thresholds as described herein. Similarly, while reference is made to determining that a rate of change is greater than or equal to a threshold rate of change (for example, the rate of change value considered as part of the phase one trigger), this may also simply involve determining if the rate of change is only greater than the threshold rate of change.

Accordingly, the phrase “does not satisfy a threshold” may be used to refer to a scenario where a value is less than or equal to, less than, greater than, or greater than or equal to a threshold (depending on the value that is being considered). The phrase “satisfy a threshold value” may refer to the opposite condition. As a non-limiting example, a battery SoC that “does not satisfy a threshold” may be a SoC that is less than or equal to a threshold, less than a threshold, etc.

In addition to the vehicle automatically taking actions to attempt to mitigate or eliminate battery drain, the vehicle may also capture and transmit relevant information that may then be viewed by a user. For example, the vehicle may transmit alerts when the vehicle SoC triggers the first phase and/or the second phase. These alerts may provide indications that the battery SoC has crossed (or met) the assigned SoC thresholds. The alerts may be transmitted to any number of different types of devices through any suitable wired or wireless communications. For example, an alert may be transmitted to a smartphone of an owner of the vehicle, a desktop or laptop computer of a mechanic for the vehicle, a tablet of a fleet manager (if the vehicle is a fleet vehicle), etc. Likewise, the vehicle may also transmit an indication when the first phase and/or the second phase is completed to provide notice to the user that the battery drain was addressed and is no longer occurring. In some instances, the alert may only be transmitted if the first phase and/or second phase is completed and the battery drain still exists.

In addition to transmitting alerts, any other relevant information may also be transmitted and/or stored for later use. Non-limiting examples of such information may include a current SoC of the battery, a rate of drain of the battery, a length of time until the battery reaches a particular SoC, a length of time until the vehicle may no longer be able to start, information about the ECUs that are still communicating even after the key-off condition, indications of the specific ECUs that were provided reset signals during the first phase or the second phase (for example, identifiers for the ECUs), and/or any other types of relevant information. This information may be usable to identify ECUs that are responsible for unintentional battery drain. Information may also be aggregated across multiple vehicles to identify specific ECUs that are prone to draining vehicle batteries (this information may be used for troubleshooting purposes).

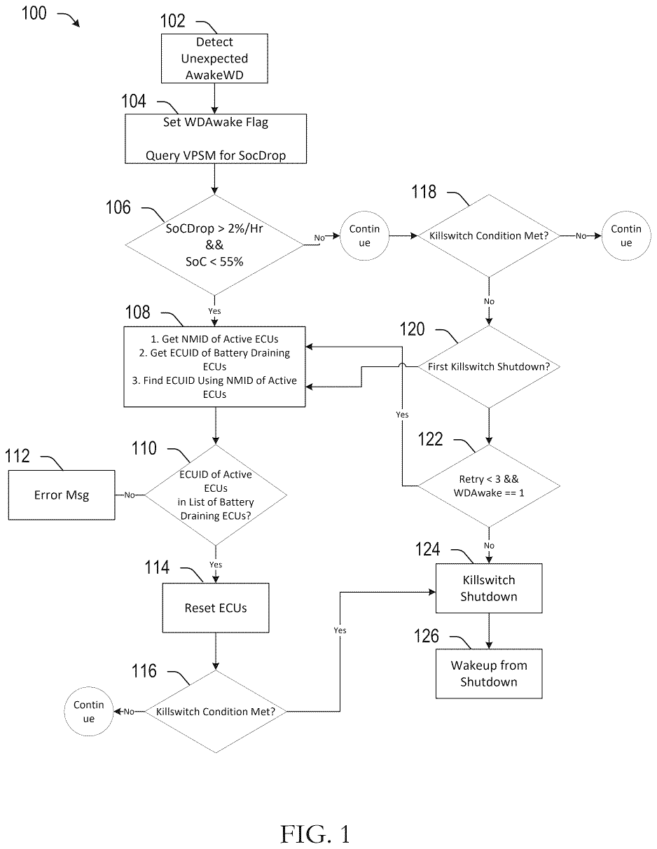

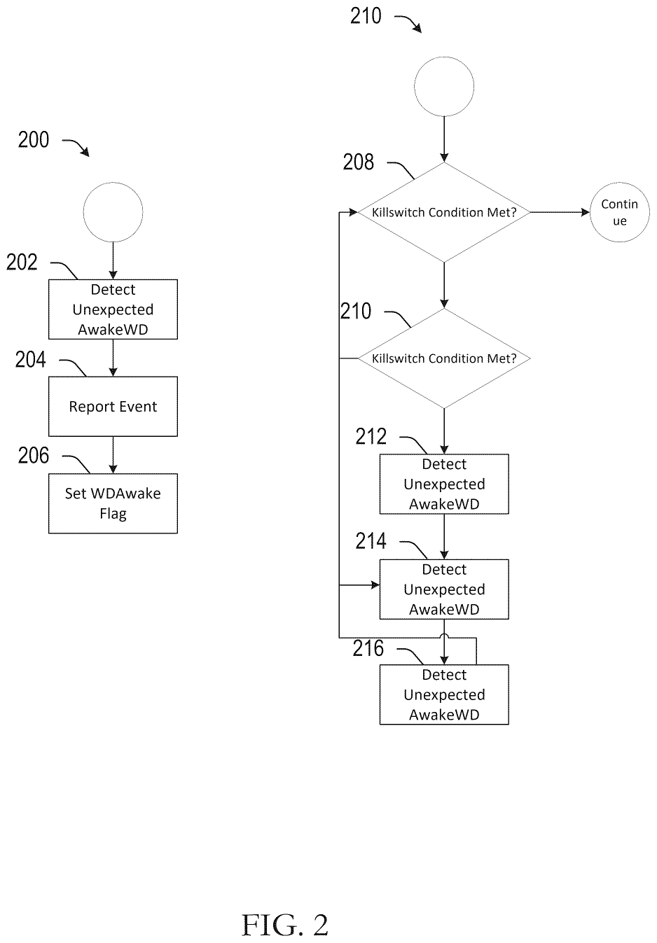

Turning to the figures, FIGS. 1-2 depict flow diagrams for mitigating vehicle battery drain. Particularly, FIG. 1 illustrates flow diagram 100, including a combination of the first phase and second phase processes as described herein. FIG. 2 is a simplified flow diagram 200, including only the second phase process as described herein.

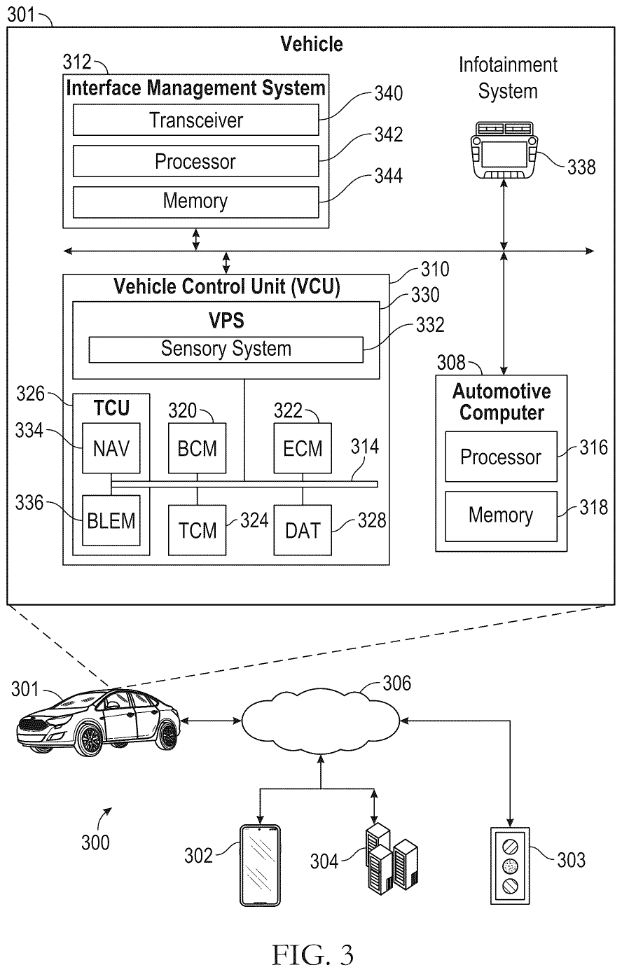

The steps shown in FIGS. 1-2 may be performed by the vehicle, including any of the individual components of the vehicle as described below with respect to FIG. 3. In one particular embodiment, the steps may be performed by the ECG of the vehicle, as indicated above (however, this is not intended to be limiting). However, this is not intended to be limiting, and the operations may also be performed by any other component with processing capabilities. The operations also do not necessarily need to be performed by the vehicle itself. Rather, instructions may be transmitted to the vehicle from a remote system, device, etc. For example, a remote server may be configured to send control instructions to the vehicle. As another example, a user may remotely control the operations of a vehicle using a smartphone application. The vehicle may also be controlled remotely in any other manner. The steps shown in the flow diagrams of FIGS. 1-2 are not necessarily comprehensive, and additional (or fewer) steps may also be performed (or some of the steps may not be performed). The order of the flow diagrams is also not intended to be limiting and the steps may be performed in any other order as well.

Beginning with FIG. 1, the flow diagram 100 begins with operation 102, which involves detecting an ECU that is still “awake” even when the vehicle is no longer in use (which may be determined based on a key-off event of the vehicle or in any other suitable manner described above or elsewhere herein). For example, the vehicle may determine that an ECU is still awake if the ECU is performing communications on the CAN bus of the vehicle, however, as previously indicated, this determination may be made in other ways. Operation 104 involves setting a flag and performing a query (for example, query the vehicle power state manager (VPSM)) to determine the battery SoC and/or rate of change of the battery SoC for the vehicle. The battery may be a battery that is used to provide power to various ECUs of the vehicle (as well as other vehicle components). For example, the battery may be the primary 12V battery in an ICE vehicle (however, other batteries may also be monitored depending on the type of vehicle). In some instances, operation 104 may be performed without first determining that an ECU is still awake. For example, the vehicle may begin monitoring SoC, rate of change of SoC, and other data immediately after the key-off event (or other condition) for the vehicle or after the pre-determined waiting time, as previously described.

Condition 106 may involve determining if the rate of change of the battery SoC is greater than or greater than or equal to a threshold rate of change (for example, the threshold rate of change may be 2% per hour or any other value). Condition 106 may also involve determining if the battery SoC does not satisfy a first threshold SoC (for example, the first threshold SoC may be 55% or any other value). That is, the condition 106 may be the condition that is used to determine if the first phase should be triggered. Condition 106 may be met if either or both of the conditions are true, for example.

If condition 106 is met, then operation 108 involves obtaining network management identifiers (NMIDs) for any actively communicating ECUs (which are ECUs that are likely to be draining the battery). These NMIDs may be obtained from communications being performed via the CAN bus. That is, any ECUs that are performing communications via the CAN bus may have an associated NMID. Operation 108 also involves obtaining identifiers for the ECUs that are currently communicating via the CAN bus (for example, the ECUs associated with the NMIDs). This may be accomplished based on a pre-existing mapping between NMIDs and associated ECU identifiers. For example, a list of ECUs that are active (this includes ECUs that are communicating on the CAN bus and ECUs that are not communicating as well) may be maintained by the vehicle or at a remote location.

Following operation 108, condition 110 involves determining if the identified ECUs are performing operations that are critical to the vehicle. The vehicle may determine if an ECU is performing a critical function in any number of different ways. For example, the vehicle may determine if certain bits are sent in communications transmitted by the ECU (which may indicate that such critical functions are being performed). As another example, the vehicle may store information about ECUs that are responsible for critical functions. If condition 110 is not met, then an error message 112 may be thrown (and a reset signal is not sent to those ECUs). If condition 110 is met, then a reset signal may be sent to those ECUs (in operation 114). Condition 110 may be considered for each individual ECU that is still awake. That is, reset signals may be sent to some ECUs and not others, depending on the functions being performed by each of the individual ECUs.

Following operation 114, condition 116 involves determining if a shutdown condition has been met. For example, the shutdown condition may involve determining if the ECU's battery SoC is also less than a second threshold SoC (which may be 40% or any other value). This condition 116 may be used to determine if the vehicle should enter the second phase following the first phase (however, in some instances, the vehicle may skip straight to the second phase depending on the current SoC and/or rate of change of the SoC.

If condition 116 is met, then the flow diagram 100 proceeds to operation 124. If condition 116 is not met, then the vehicle may continue performing its routine operations (this applies to any portion of a flow diagram, including a “continue” block). For example, if the ECG is performing the analyses shown in the flow diagram 100, then the ECG may continue normal operations if condition 116 is not met. In some cases, normal operations may include iterating through the flow diagram 100 until the condition is met.

Returning to condition 106, if condition 106 is not met, then the flow diagram 100 proceeds to condition 118. Condition 118 also involves determining if the shutdown condition is met (as aforementioned, the shutdown condition may involve determining if the SoC is less than the second threshold). If condition 118 is not met, then the vehicle may continue performing its routine operations. For example, if the ECG is performing the analyses shown in the flow diagram 100, then the ECG may continue normal operations if condition 116 is not met. If condition 118 is met, then condition 120 involves determining if this will be the first time that a self-reset of the ECG has been performed. If condition 120 is met, then the flow diagram 100 proceeds to operation 108.

If condition 120 is not met, however, the flow diagram 100 proceeds to condition 122. Condition 122 involves determining if the vehicle has already iterated through the process and attempted to reset the ECUs, causing the battery to drain a threshold number of times (the figure shows a value of three, however, this is not intended to be limiting). Condition 122 also involves determining if vehicle ECUs are still awake. If condition 122 is met, then the flow diagram 100 proceeds to operation 108. If condition 122 is not met, then operation 124 involves performing a self-reset of the ECG. Operation 126 involves the ECU(s) waking up from the shutdown. The flow diagram 100 then returns to condition 118.

Turning to FIG. 2, a second set of flow diagrams (flow diagram 200 and flow diagram 210) are shown that only include steps associated with the phase two processes described above. That is, the flow diagrams 200 and 210 are a simplified version of the flow diagram 100 that do not first attempt to mitigate the battery drain without self-resetting the ECG.

The flow diagram 200 begins with operation 202, which involves detecting an ECU that is still “awake” even when the vehicle is no longer in use (which may be determined based on a key-off event of the vehicle or in any other suitable manner). For example, the vehicle may determine that an ECU is still awake if it is performing communications on the CAN bus of the vehicle, however, as previously indicated, this determination may be made in other ways. Operation 204 involves reporting a QUIP event and Operation 206 involves setting a flag and performing a query to determine the battery SoC and/or rate of change of the battery SoC for the vehicle.

Flow diagram 210 begins with condition 208, which involves determining if a shutdown condition has been met. For example, the shutdown condition may involve determining if the ECU's battery SoC is also less than the second threshold SoC (which may be 40% or any other value).

If condition 208 is met, then the flow diagram 210 proceeds to operation 210. If condition 208 is not met, then the vehicle may continue performing its routine operations. For example, if the ECG is performing the analyses shown in the flow diagram 200, then the ECG may continue normal operations if condition 208 is not met. In some cases, normal operations may include iterating through the flow diagram 210 until the condition is met.

Condition 210 involves determining if the vehicle has already iterated through the process and attempted to self-reset the ECG a threshold number of times (the figure shows a value of three, however, this is not intended to be limiting). Condition 210 also involves determining if vehicle ECUs are still awake. If condition 210 is met, then the flow diagram 210 proceeds to operation 212. Operation 212 involves sending reset signals to any active ECUs. If condition 210 is not met, then operation 214 involves self-resetting the ECG. Operation 216 involves the ECUs and/or ECG waking up from the shutdown.

FIG. 3 depicts a block diagram of a system 300 for mitigating vehicle battery drain in accordance with the present disclosure. The vehicle 301 and/or the driver implement and/or perform operations, as described here in the present disclosure, in accordance with the owner manual and safety guidelines. In addition, any action taken by the driver based on the notifications and/or alerts provided by the vehicle 301 should comply with all the rules specific to the location and operation of the vehicle 301 (e.g., Federal, state, country, city, etc.). The notifications and/or alerts, as provided by the vehicle 301, should be treated as suggestions and only followed according to any rules specific to the location and operation of the vehicle 301.

The system 300 may include the one or more vehicles 301, a user device 302, infrastructure 303, and one or more servers 304 (or server 304), communicatively coupled with each other via one or more networks 306 (or a network 306). Any reference to a single element (e.g., a “server 304,” etc.) may similarly refer to any other number of such elements. Similarly, reference to multiple of such elements may also refer to a single element as well.

The user device 302 may be associated with a user and may be, for example, a mobile phone, a laptop, a computer, a tablet, a wearable device, or any other similar device with communication capabilities. The server 304 may be configured to receive data from the one or more vehicles 301, infrastructure 303, and/or any other devices that are configured to capture data about a location. The server 304 may also be configured to process any of the data as described herein. As aforementioned, some or all of the processing may also be performed by the one or more vehicles 301, the user device 302, etc. That is, any of the steps described with respect to FIGS. 1-2 (as well as any other processing associated with the first phase, second phase, and/or any other aspects of the battery draining mitigation techniques described herein) may be performed by the one or more vehicles 301, user device 302, infrastructure 303, server 304, or any combination of these elements of the system 300.

The network 306 illustrates an example communication infrastructure in which the connected devices discussed in various embodiments of this disclosure may communicate. The network 306 may be and/or include the Internet, a private network, public network, or other configuration that operates using any one or more known communication protocols such as transmission control protocol/Internet protocol (TCP/IP), Bluetooth®, BLE, Wi-Fi based on the Institute of Electrical and Electronics Engineers (IEEE) standard 802.11, Ultra-Wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

Any of the elements of the system 300 may also form a mesh network. This may be beneficial in scenarios in which a particular device is not connected to a wide-area network and is not able to transmit data over large distances (for example, from a vehicle to server 304). In such scenarios, the device that is unable to perform long-range communications may still be able to perform short-range communications with other proximate devices. For example, traffic infrastructure may capture an image of a location but may be unable to transmit the data to server 304. Instead, the traffic infrastructure may transmit the image to a vehicle in the vicinity and the vehicle may then transmit the data to server 304. Such data transmissions may also be performed between any other types of devices.

The one or more vehicles 301 may include a plurality of units including, but not limited to, an automotive computer 308, a Vehicle Control Unit (VCU) 310, and an interface management system 312 (or system 312). The VCU 310 may include a plurality of Electronic Control Units (ECUs) 314 disposed in communication with the automotive computer 308.

In some aspects, the user device 302 may be configured to connect with the automotive computer 308 and/or the system 312 via the network 306, which may communicate via one or more wireless connection(s), and/or may connect with the one or more vehicles 301 directly by using near field communication (NFC) protocols, Bluetooth® protocols, Wi-Fi, Ultra-Wideband (UWB), and other possible data connection and sharing techniques.

The automotive computer 308 and/or the system 312 may be installed anywhere in the one or more vehicles 301, in accordance with the disclosure. Further, the automotive computer 308 may operate as a functional part of the system 312. The automotive computer 308 may be or include an electronic vehicle controller, having one or more processor(s) 316 and a memory 318. Moreover, the system 312 may be separate from the automotive computer 308 (as shown in FIG. 3) or may be integrated as part of the automotive computer 308.

The processor(s) 316 may be disposed in communication with one or more memory devices disposed in communication with the respective computing systems (e.g., the memory 318 and/or one or more external databases not shown in FIG. 3). The processor(s) 316 may utilize the memory 318 to store programs in code and/or to store data for performing aspects in accordance with the disclosure. The memory 318 may be a non-transitory computer-readable storage medium or memory storing an interface management program code. The memory 318 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In accordance with some aspects, the VCU 310 may share a power bus with the automotive computer 308 and may be configured and/or programmed to coordinate the data between vehicle systems, connected servers (e.g., the server 304), and other vehicles (not shown in FIG. 3) operating as part of a vehicle fleet. The VCU 310 may include or communicate with any combination of the ECUs 314, such as, for example, a Body Control Module (BCM) 320, an Engine Control Module (ECM) 322, a Transmission Control Module (TCM) 324, a Telematics Control Unit (TCU) 326, a Driver Assistances Technologies (DAT) controller 328, etc. The VCU 310 may further include and/or communicate with a Vehicle Perception System (VPS) 330, having connectivity with and/or control of one or more vehicle sensory system(s) 332. The vehicle sensory system 332 may include one or more vehicle sensors including, but not limited to, a Radio Detection and Ranging (RADAR or “radar”) sensor configured for detection and localization of objects inside and outside the one or more vehicles 301 using radio waves, sitting area buckle sensors, sitting area sensors, a Light Detecting and Ranging (“lidar”) sensor, door sensors, proximity sensors, temperature sensors, wheel sensors, one or more ambient weather or temperature sensors, vehicle interior and exterior cameras, steering wheel sensors, a vehicle accelerometer, a vehicle gyroscope, a vehicle magnetometer, ultrasonic sensors, etc.

In some aspects, the vehicle sensory system 332 may be configured to capture data about a location. For example, the vehicle sensory system 332 may include one or more cameras that may be configured to capture images and/or video of a location. The vehicle sensory system 332 may also include any other types of sensors that may capture any other types of data (for example, temperature sensors, location sensors, radar, LIDAR, accelerometers, etc.).

In some aspects, the VCU 310 may control vehicle operational aspects and implement one or more instruction sets received from the server 304, from one or more instruction sets stored in the memory 318, including instructions operational as part of the system 312.

The TCU 326 may be configured and/or programmed to provide vehicle connectivity to wireless computing systems onboard and off board the one or more vehicles 301 and may include a Navigation (NAV) receiver 334 for receiving and processing a GPS signal, a BLE® Module (BLEM) 336, a Wi-Fi transceiver, an ultra-wideband (UWB) transceiver, and/or other wireless transceivers (not shown in FIG. 3) that may be configurable for wireless communication (including cellular communication) between the one or more vehicles 301 and other systems (e.g., a vehicle key fob, not shown in FIG. 3, the server 304, the user device 302, the infrastructure 303, etc.), computers, and modules. The TCU 326 may be disposed in communication with the ECUs 314 by way of a bus.

The ECUs 314 may control aspects of vehicle operation and communication using inputs from human drivers, inputs from the automotive computer 308, the system 312, and/or via wireless signal inputs/command signals received via the wireless connection(s) from other connected devices, such as the server 304, the user device 302, the interface 110, among others.

The BCM 320 generally includes integration of sensors, vehicle performance indicators, and variable reactors associated with vehicle systems and may include processor-based power distribution circuitry that may control functions associated with the vehicle body such as lights, windows, security, camera(s), audio system(s), speakers, wipers, door locks and access control, various comfort controls, etc. The BCM 320 may also operate as a gateway for bus and network interfaces to interact with remote ECUs (not shown in FIG. 3). In some aspects, the BCM 320 may be configured to cause and control the vehicle movement and the vehicle steering wheel rotation based on the command signals (or the user inputs) obtained from the interface 110 and/or the system 312.

The DAT controller 328 may provide Level-1 through Level-3 automated driving and driver assistance functionality (or any other type of autonomous driving functionality at any level) that may include, for example, active parking assistance, vehicle backup assistance, and/or adaptive cruise control, among other features. The DAT controller 328 may also provide aspects of user and environmental inputs usable for user authentication.

In some aspects, the automotive computer 308 may connect with an infotainment system 338 (or a vehicle Human-Machine Interface (HMI)). The infotainment system 338 may include a touchscreen interface portion and may include voice recognition features, biometric identification capabilities that may identify users based on facial recognition, voice recognition, fingerprint identification, or other biological identification means. In other aspects, the infotainment system 338 may be further configured to receive user instructions via the touchscreen interface portion and/or output or display notifications, navigation maps, etc., on the touchscreen interface portion.

The computing system architecture of the automotive computer 308, the VCU 310, and/or the system 312 may omit certain computing modules. It should be readily understood that the computing environment depicted in FIG. 2 is an example of a possible implementation according to the present disclosure, and thus, it should not be considered as limiting or exclusive.

In accordance with some aspects, the system 312 may be integrated with and/or executed as part of the ECUs 314. The system 312, regardless of whether it is integrated with the automotive computer 308 or the ECUs 314, or whether it operates as an independent computing system in the one or more vehicles 301, may include a transceiver 340, a processor 342, and a computer-readable memory 344.

The transceiver 340 may be configured to receive information/inputs from one or more external devices or systems, e.g., the user device 302, the server 304, the infrastructure 303, and/or the like, via the network 306. Further, the transceiver 340 may transmit notifications, requests, signals, etc., to the external devices or systems. In addition, the transceiver 340 may be configured to receive information/inputs from vehicle components such as the vehicle sensory system 332, one or more ECUs 314, and/or the like. Further, the transceiver 340 may transmit signals (e.g., command signals) or notifications to the vehicle components such as the BCM 320, the infotainment system 338, and/or the like.

The processor 342 and the memory 344 may be same as or similar to the processor 316 and the memory 318, respectively. In some aspects, the processor 342 may utilize the memory 344 to store programs in code and/or to store data for performing aspects in accordance with the disclosure. The memory 344 may be a non-transitory computer-readable storage medium or memory storing the interface management program code. In some aspects, the memory 344 may additionally store any data obtained by the one or more vehicles 301, infrastructure 303, etc., any post-processed data (e.g., classified images, etc.), any requests to view different types of environmental conditions, and/or any other types of information.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application-specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not function.

It should also be understood that the word “example,” as used herein, is intended to be non-exclusionary and non-limiting in nature. More particularly, the word “example,” as used herein, indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices, such as those listed above, and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A vehicle comprising:
memory that stores computer-executable instructions; and
one or more processors configured to access the memory and execute the computer-executable instructions to:
determine that a key-off event has occurred;
determine that a battery state of charge (SoC) of the vehicle does not satisfy a first threshold value;
determine that a rate of change of the battery SoC does not satisfy a second threshold value;
determine that a first electronic control unit (ECU) of the vehicle is still operational; and
send a reset signal to the first ECU of the vehicle.

2. The vehicle of claim 1, wherein the one or more processors are further configured to execute the computer-executable instructions to:
determine that the battery SoC does not satisfy a third threshold value, wherein the third threshold value is less than the first threshold value; and
perform a self-reset of an enhanced central gateway (ECG) of the vehicle.

3. The vehicle of claim 1, wherein determining that the first ECU is still operational, further comprises:
determine that the first ECU is still performing communications on a controller area network (CAN) bus of the vehicle.

4. The vehicle of claim 1, wherein the one or more processors are further configured to execute the computer-executable instructions to:
determine that a second ECU of the vehicle is still operational;
determine that the second ECU is performing a critical function of the vehicle; and
prevent, based on determining that the second ECU is performing the critical function, a reset signal from being sent to the second ECU.

5. The vehicle of claim 1, wherein the one or more processors are further configured to execute the computer-executable instructions to:
transmit an alert to a remote device indicating that the battery SoC does not satisfy the first threshold value.

6. The vehicle of claim 1, wherein the one or more processors are further configured to execute the computer-executable instructions to:
transmit a message including an identifier for the first ECU and an indication that the first ECU was reset.

7. The vehicle of claim 1, wherein the one or more processors are further configured to execute the computer-executable instructions to:
automatically adjust at least one of: the first threshold value or the second threshold value.

8. A method comprising:
determining, by a vehicle, that a key-off event has occurred;
determining, by the vehicle, that a battery state of charge (SoC) of the vehicle does not satisfy a first threshold value;
determining, by the vehicle, that a rate of change of the battery SoC does not satisfy a second threshold value;
determining, by the vehicle, that a first electronic control unit (ECU) of the vehicle is still operational; and
sending, by the vehicle, a reset signal to the first ECU of the vehicle.

9. The method of claim 8, further comprising:
determining that the battery SoC does not satisfy a third threshold value, wherein the third threshold value is less than the first threshold value; and
performing a self-reset of an enhanced central gateway (ECG) of the vehicle.

10. The method of claim 9, wherein determining that the first ECU is still operational, further comprises:
determining that the first ECU is still performing communications on a controller area network (CAN) bus of the vehicle.

11. The method of claim 8, further comprising:
determining that a second ECU of the vehicle is still operational;
determining that the second ECU is performing a critical function of the vehicle; and
preventing, based on determining that the second ECU is performing a critical function, a reset signal from being sent to the second ECU.

12. The method of claim 8, further comprising:
transmitting an alert to a remote device indicating that the battery SoC does not satisfy the first threshold value.

13. The method of claim 8, further comprising:
transmitting a message including an identifier for the first ECU and an indication that the first ECU was reset.

14. The method of claim 8, further comprising:
automatically adjusting at least one of: the first threshold value or the second threshold value.

15. A system comprising:
memory that stores computer-executable instructions; and
one or more processors configured to access the memory and execute the computer-executable instructions to:
determine that a key-off event of a vehicle has occurred;
determine that a battery state of charge (SoC) does not satisfy a first threshold value;
determine that a rate of change of the battery SoC does not satisfy a second threshold value;
determine that a first electronic control unit (ECU) of the vehicle is still operational; and
send a reset signal to the first ECU of the vehicle.

16. The system of claim 15, wherein the one or more processors are further configured to execute the computer-executable instructions to:
determine that the battery SoC does not satisfy a third threshold value, wherein the third threshold value is less than the first threshold value; and
perform a self-reset of an enhanced central gateway (ECG) of the vehicle.

17. The system of claim 15, wherein determining that the first ECU is still operational further comprises:
determining that the first ECU is still performing communications on a controller area network (CAN) bus of the vehicle.

18. The system of claim 15, wherein the one or more processors are further configured to execute the computer-executable instructions to:
determine that a second ECU of the vehicle is still operational;
determine that the second ECU is performing a critical function of the vehicle; and
prevent, based on determining that the second ECU is performing the critical function, a reset signal from being sent to the second ECU.

19. The system of claim 15, wherein the one or more processors are further configured to execute the computer-executable instructions to:
transmit an alert to a remote device indicating that the battery SoC does not satisfy the first threshold value.

20. The system of claim 15, wherein the one or more processors are further configured to execute the computer-executable instructions to:
transmit a message including an identifier for the first ECU and an indication that the first ECU was reset.
